(19) United States
(12) Patent Application Publication
(10) Pub. No.: US 2003/0129319 A1
(43) Pub. Date: Jul. 10, 2003

(54) Method of preventing re-swelling of a compressed wooden blank

(76) Inventor: Ingvar Johansson, Horn (SE)

Correspondence Address: YOUNG & THOMPSON, 745 SOUTH 23RD STREET 2ND FLOOR, ARLINGTON, VA, 22202

(21) Appl. No.: 10/221,651

(22) PCT Filed: Mar. 16, 2001
(86) PCT No.: PCT/SE01/00549

(30) Foreign Application Priority Data
Mar. 16, 2000 (SE) 0000870-6

(51) Int. Cl. B05D 1/18; C09D 5/14; C09D 4/00; C08L 91/00

(52) U.S. Cl. 427/440; 106/18; 106/253; 106/263; 106/252

(57) ABSTRACT

A method of preventing re-swelling of a compressed wooden blank, includes the steps of: a) providing a blank of compressed wood; b) exposing the blank to a reduced gas pressure of at most 0.5 atm; c) submerging the blank in a volume-stabilising composition containing a hydrophobic base component and an additive which is compatible with the hydrophobic base component and which includes one or more hydrophilic groups chosen from carboxyl-, hydroxy- and amino groups; d) exposing the blank to a higher pressure than in step b) over a predetermined period of time while keeping the blank submerged in the volume-stabilising composition; and e) removing the blank from the composition. Steps b) and step c) are carried out simultaneously.

### FIELD OF INVENTION

The present invention relates to a method of preventing re-swelling of a blank comprised of compressed wood. The invention also relates to volume stabilising compositions and the use of such compositions in preventing re-swelling of a blank comprised of compressed wood.

### BACKGROUND ART

Different woods have long been compressed with the intention of improving the properties of the wood, such as to enhance its mechanical strength or its wear strength. The use of compressed wood is of particular interest in furniture manufacture and in the production of flooring materials and other furnishing elements.

However, compressed wood can swell or “spring back” to its original non-compressed state subsequent to contact with water in one form or another. This is due to the pronounced stresses and strains that build-up in the material as it is compressed, whereby these stresses are able to trigger movements in the substantially hydrophilic wood material when it is exposed to moisture. Such movements will result in a reduction in mechanical strength and also in wear strength and the properties of the wood material will lie close to the properties of untreated wood. Furthermore, this “spring-back” of the wood subsequent to its exposure to moisture is often uneven, and consequently a surface that is smooth after compression may have a fluted appearance subsequent to its contact with moisture. There is therefore a requirement for processes that result in preserving the volumes of compressed wooden blanks, and in this way also preserve those properties of the wood material that have been achieved by compression.

SE, C, 500 308 teaches a method of hardening wood in which the wood is impregnated with a polymerisable monomer for subsequent locking of the wood in its compressed state. However, this method has several drawbacks. The majority of woods that are the subject of compression in the present context, e.g. pine and spruce, are difficult to impregnate. Consequently, it is difficult to achieve uniform distribution of the locking chemical in the wood material. The locking effect is therefore uneven after compressing the wood. For reasons of both a functional and environmental nature, water is preferably used as the monomer solvent. It is necessary to dry-off the water prior to compression. If drying is effected at elevated temperatures, there is a risk that curing of the monomer will begin before the wood is compressed. This counteracts satisfactory compression and will often result in the wood cracking. If, on the other hand, drying is effected at low temperatures (air-drying), the time taken to dry out the wood is often unacceptably long. Polymerisation is achieved at a high temperature considerably above 100° C. Such a high temperature will harm the wooden product.

There is thus a need of an improved method for locking compressed wood and in this way prevent re-swelling and spring-back of compressed wood.

### SUMMARY OF THE INVENTION

It has now been found that the aforementioned problems concerning the re-swelling of compressed wooden blanks can be overcome with a method that comprises the steps of

a) providing a blank consisting of compressed wood;

b) exposing the blank to a reduced gas pressure of at most 0.5 atm, preferably at most 0.2 atm;

c) submerging the blank in a volume-stabilising composition having a viscosity of at most 100 cP and containing i) a hydrophobic base component comprising an air-drying polyunsaturated oil and ii) at least one additive which is compatible with the hydrophobic base component and is chosen from iia) one or more monocarboxylic acids containing 8-25 carbon atoms in a straight or branched chain having double and triple bonds, for example oleic acid, linoleic acid and linolenic acid, or mixtures of such carboxylic acids, and/or iib) an alcohol such as isopropyl alcohol;

d) exposing the blank to a higher pressure than in step b) over a predetermined period of time whilst keeping the blank submerged in said volume-stabilising composition; and

e) removing the blank from the composition, that part of the composition located on the surfaces of the blank being sucked into said blank and the surfaces of said blank becoming dry,

wherein step b) and step c) are carried out at one and the same time during at least a part of the process.

### DETAILED DESCRIPTION OF THE INVENTION

Thus, in accordance with a first embodiment, the invention relates to a process for preventing re-swelling of a blank comprised of compressed wood. The wooden blank may, in principle, have been compressed in any known manner whatsoever. However, the invention can be applied with particular benefit to wood that has been compressed isostatically in accordance with the technology described in WO 95/13908, such wood being liable to swell significantly after being exposed to moisture.

Without being tied to any particular theory, it is assumed that the cell structure of wood is partially opened as the wood is compressed. A compressed wooden blank becomes more permeable at the same time as its density increases.

The inventive process includes a step in which the compressed blank is exposed to a reduced gas pressure of at most 0.5 atm, preferably at most 0.2 atm, and typically about 0.05 atm. This results in an increase in the absorbency of the wooden blank. Within being tied to any particular theory, it is assumed that this is because some of the air in the wooden blank is withdrawn therefrom and that, subsequent to treatment, the pressure in the blank interior is lower than the ambient pressure. This process step is normally carried out by placing the blank in a gas-tight space and then evacuating the air from said space. The lowest possible pressure is preferred in this respect. The choice of pressure and exposure time is controlled by carefully weighing up the pros and cons between costs (equipment costs, operational costs) on the one hand and the obtainment of reasonable absorbency of the treated wooden blank on the other hand. A higher pressure than 0.5 atmospheres will mean that absorption will take an unreasonably long time to take place. There is also a danger that the impregnating agent will not completely penetrate the blank. A larger blank will normally require a longer exposure time and/or a lower pressure, A typically exposure time is from 1 to 24 hours, and preferably from 2 to 4 hours inclusive.

The blank is treated with a volume stabilising composition, either prior to or at the same time as the treatment with reduced gas pressure. In this regard, it is necessary for the composition to come into contact with the blank from all sides. This is normally achieved in practice, by submerging the blank in the composition so that the composition will be sucked into the blank. It is important that the viscosity of the composition is not so high as to prevent the composition from being sucked into the entire blank and not solely into its outer surface. A viscosity of 100 cP is a practical upper limit in this respect. The duration of the treatment is chosen so that the composition has time to be sucked into the whole of the blank. This will typically take from 6 to 24 hours inclusive. After having submerged, immersed, the blank, it takes typically about 30 minutes for the blank surfaces to dry. A large blank will normally require a longer treatment time than a small blank.

It is not necessary to use heating in the present treatment. It may however in certain cases be of advantage to use a mild heating to achieve polymerisation of a component in the volume-stabilising composition. Contrary to what is described in SE,C, 500 308 such heating will be performed at a temperature well below 100° C.

A second embodiment of the invention relates to a volume-stabilising composition. In order to prevent swelling of the wood with its essentially hydrophilic structure, the volume-stabilising composition is based on a base component and also contains at least one additive. The base component may consist of i) an air-drying polyunsaturated oil. Examples of air-drying polyunsaturated oils are linseed oil, raps oil, olive oil and sunflower oil. It is important that the viscosity of the composition not exceed 100 cP. The ability of the composition to penetrate into the wood material decreases with increased viscosity. The viscosity of the composition can be lowered and thereby enable more viscous oils to be included, by adding an organic hydrophobic solvent or an active diluent. Examples of suitable active diluents are ethyl esters of fatty acids.

The additive ii) which is compatible with the hydrophobic base component is chosen from iia) one or more monocarboxylic acids containing 8-25 carbon atoms in a straight or branched chain having double and triple bonds, for example oleic acid, linoleic acid and linolenic acid, or mixtures of such carboxylic acids, and iib) an alcohol such as isopropyl alcohol.

In an alternative embodiment of the process the wooden blank i first treated with the additive ii) of the volume-stabilising composition which is comprised of one or more fatty acids, i.e. monocarboxylic acids having 8-25 carbon atoms either in a straight or branched chain that contains double and triple bonds. Examples of suitable fatty acids are oleic acid, linoleic acid and linolenic acid. Preparations that include several different fatty acids are preferred, for cost reasons. An example of one suitable preparation is SYLFAT® 2S (Arizona Chemical, USA) which contains 96% free fatty acids and which is produced from tall oil. Such treatment is primarily suitable for use with hardwood, for instance alder and birch.

When this alternative is used the blank is subsequently treated with the base component comprising air-drying polyunsaturated oils such as linseed oil, raps oil, olive oil and sunflower oil under the same conditions as the first treatment. The first treatment facilitates the penetration of the oils into the wood in the second treatment. The second component i) may also contain a solvent or an active diluent and possibly also some property enhancing additive such as a colorant. Preferably the treatment is performed so that the blank after the treatment will have an acid content of 20-80% by weight, especially an acid content of 40-50% by weight.

One or more fatty acids can be used as the additive substance ii) compatible with the base component i), i.e. monocarboxylic acids having 8-25 carbon atoms in a straight or branched chain that contains double and triple bonds. Examples of suitable fatty acids are oleic acid, linoleic acid and linolenic acid. Preparations that include several different acids are preferred, for cost reasons. An example of one suitable preparation is SYLFAT® 2S (Arizona Chemical, USA) which contains 96% free fatty acids and which is produced from tall oil. Different alcohols, such as isopropyl alcohol, can also be used as additives together with the air-drying oils.

The carboxylic acid ends of the fatty acids have affinity to the hydrophilic structures of the wood material, whilst their hydrocarbon ends have affinity to the oil. The oil is in this way locked in the wood structure, making it difficult for moisture to penetrate into the wood. The concentration of free fatty acid in the composition can vary between 1-50 percent by volume, preferably being 10-30%, especially about 15-20%. Excessively high and excessively low concentrations will both result in re-swelling of the wood. The person skilled in this art will be able to determine an appropriate concentration, with the aid of simple experiments.

When the volume-stabilising composition contains one or more polyunsaturated oils, it is beneficial to add siccatives that accelerate autooxidation of the oils with O₂. Siccatives are thus catalysts. They are oil-soluble alcoholates, soaps, complexes, or metal organic compounds of Co, Mn, Zr, Ca and Ba. The siccative used in the following embodiment contains 6% Co and 9% Zr and is retailed under the name Mixed Drier VX 73 Björn Fredlund AB, Sweden).

Other property improving additives may also be added to the volume-stabilising composition, for instance insecticides, fungicides and oil-soluble dyes or colorants.

The invention will now be described with reference to exemplifying embodiments thereof. The examples constitute illustrations of different embodiments and are not intended to limit the scope of the invention.

### EXAMPLE 1

Compressed pine planks having a thickness of 20 mm and a width of 150 mm and a density Of 1.09 g/cm³ were impregnated with a mixture of 80% (by weight) linseed oil (Purolin, Linraff AB, Sweden) that had a viscosity of 40 cP and 19% (by weight) free fatty acids (SYLFAT®2S, Arizona Chemical, USA) containing 0.1% siccative calculated on linseed oil+fatty acids and 1% (by weight) colorant (Sudan® Green 985, BASF, DE). The planks were exposed to a vacuum of 0.05 atm whilst submerged in the mixture. The pressure was increased to atmospheric pressure after 4 hours with the planks still submerged in the mixture. The planks were kept submerged in this way for one calendar day, after which they were removed from the mixture. The planks were surface dry and coloured throughout within about 30 minutes. The oil take-up was about 20% calculated on the startin weight of the planks. No swelling was recorded. Subsequent to immersing the planks in water for 2 hours, re-swelling of the wood was determined as being about 2% of the re-swelling occurring with corresponding compressed planks that had not undergone the above treatment.

### EXAMPLE 2

4 mm thick compressed wear layers comprised of spruce and having a density of 0.86 g/cm³ were impregnated with linseed oil (Purolin 2, Linraff AB, Sweden) that had a viscosity of 50 cP and contained 10% (by weight) isopropyl alcohol, 0.1% (by weight) siccative calculated on the linseed oil, and about 0.25% (by weight) colorant (Sudan® Green 985, BASF, DE). The wood material was submerged in the aforesaid mixture and then evacuated to an air pressure of 0.05 atm and kept at this pressure for 2 hours. The pressure was allowed to rise to atmospheric pressure at the end of this time period, while keeping the wood material submerged. The wood material was kept submerged overnight, whereafter it was removed from the mixture. The material was surface dry and coloured throughout within about 30 minutes. No swelling could be noted. The oil take-up was about 25% calculated on the starting weight. After holding the wood immersed in water for 2 hours, re-swelling of the wood was determined as 2% of the re-swelling occurring with corresponding compressed planks that had not undergone the above treatment.

### EXAMPLE 3

A compressed birch wear surface having a thickness of 10 mm and a density of 1.03 g/cm³ was impregnated with a mixture of 75% (by weight) linseed oil (Purolin, Linraff AB, Sweden) having a viscosity of 40 cP, 15% (by weight) free fatty acids (SYLFAT®2S) and 10% (by weight) furfuryl alcohol, and 0.1% (by weight) p-toluene sulfonic acid calculated on the amount of furfuryl alcohol present. The wood material was first evacuated over a period of 4 hours to a pressure of 0.05 atm. The aforesaid mixture was then applied so as to fully cover the wood material, whereafter the pressure was allowed to rise to atmospheric pressure with the wood still submerged in the mixture. The wood samples were kept submerged overnight, after which they were removed from the mixture. The material was surface dry after about 30 minutes. The material was then heated to 75° C. for 5 hours, so as to polymerise the furfuryl alcohol. The material was through-coloured in a brown tone. The oil take-up was about 20% calculated on the starting weight. No re-swelling of the wood could be noted. Re-swelling when holding the wood submersed in water for 2 hours was determined as being 2% of the re-swelling obtained with corresponding compressed planks that had not undergone the above treatment.

### EXAMPLE 4

The active diluent used in this example is a mixture of ethyl monoesters of fatty acids comprising oleic acid, linoleic acid and linolenic acid in the same proportions as in linseed oil.

Compressed pine planks having a thickness of 20 mm and a density of 0.85 g/cm³ were first impregnated in a first oil composed of free fatty acids (SYLFAT®2S) containing 0.1% siccative. The planks submerged in the oil were first evacuated 4 hours at a vacuum of 0.05 atm. Then the pressure was increased to atmospheric pressure with the planks still submerged in the oil. The planks were submerged for another 4 hours after which they were removed from the oil and directly submerged in a second oil composed of a mixture of 90% (by weight) linseed oil (Purolin, Linraff AB) that had a viscosity of 40 cP and 10% (by weight) active diluent (LINUTIN 2, Linraff AB) containing 0.1% siccative calculated on the mixture. The planks were submerged another 16 hours and were then removed from the mixture. The planks were surface dry within about 30 minutes. The total oil take-up was about 25% calculated on the starting weight of the planks. The take-up consisted to about 50% of the first oil and to about 50% of the second oil. No swelling was recorded.

1 A method of preventing re-swelling of a compressed wooden blank, comprising the steps of
f) providing a blank consisting of compressed wood;
g) exposing the blank to a reduced gas pressure of at most 0.5 atm, preferably at most 0.2 atm;
h) submerging the blank in a volume-stabilising composition having a viscosity of at most 100 cP and containing i) a hydrophobic base component comprising an air-drying polyunsaturated oil and ii) at least one additive which is compatible with the hydrophobic base component and is chosen from iia) one or more monocarboxylic acids containing 8-25 carbon atoms in a straight or branched chain having double and triple bonds, for example oleic acid, linoleic acid and linolenic acid, or mixtures of such carboxylic acids, and/or iib) an alcohol such as isopropyl alcohol.
i) exposing the blank to a higher pressure than in step b) over a predetermined period of time whilst keeping the blank submerged in said volume-stabilising composition; and
j) removing the blank from the composition, that part of the composition located on the surfaces of the blank being sucked into said blank and the surfaces of said blank becoming dry,
wherein step b) and step c) are carried out at one and the same time during at least a part of the process.

2. A method according to claim 1, characterised by exposing the blank in step b) to a reduced gas pressure over a period of 1-24 hours, and preferably for 2-4 hours inclusive.

3. A method according to any one of the preceding claims, characterised by exposing the blank in step c) to said volume-stabilising composition for a period of 6-24 hours inclusive.

4. A method according to any one of the preceding claims, characterised in that
i) the air-drying polyunsaturated oil is chosen from the group of linseed oil, raps oil, olive oil and sunflower oil.

5. A method according to claim 4, characterised in that the volume-stabilising composition comprises i) a base component consisting of an air-drying oil and ii) an additive which is one or more monocarboxylic acids.

6. A method according to claim 5, characterised in that the volume-stabilising composition has an acid content of at most 50%, preferably a content of 10-30% by weight, especially a content of about 15-20% by weight.

7. A method according to claim 1, characterised in that
the blank in step c) is submerged in a first volume-stabilising composition comprising a base component which is one or more monocarboxylic acids containing 8-25 carbon atoms in a straight or branched chain having double and triple bonds, for example oleic acid, linoleic acid and linolenic acid, and mixtures of such carboxylic acids;
that the blank after step d) is removed from the first volume-stabilising composition and directly submerged in a second volume-stabilising composition comprising a base component which is an air-drying polyunsaturated oil chosen from the group of linseed oil, raps oil, olive oil and sunflower oil; possibly also comprising an active diluent,
that steps b)-d) are repeated with the second composition before step e) is performed.

8. A method according to any of the preceding claims, characterised in that the volume-stabilising composition also includes at least one property improving chemical chosen from among insecticides, fungicides and oil soluble dyes or colorants.

9. A volume-stabilising composition suitable for use in the method according to claim 1, characterised in that said composition has a viscosity of at most 100 cP and includes
i) a hydrophobic base component comprising an air-drying polyunsaturated oil and
ii) at least one additive which is compatible with the hydrophobic base component and is chosen from iia) one or more monocarboxylic acids containing 8-25 carbon atoms in a straight or branched chain having double and triple bonds, for example oleic acid, linoleic acid and linolenic aid, or mixtures of such carboxylic acids, and/or iib) an alcohol such as isopropyl alcohol.

10. A volume-stabilising composition according to claim 9, characterised in that it further includes at least one property improving chemical chosen from the group of insecticides, fungicides and oil soluble dyes or colorants.

11. The use of a composition according to any one of claims 9 or 10 for preventing re-swelling of a blank comprised of compressed wood.
